(19) United States
(12) Patent Application Publication
(10) Pub. No.: US 2025/0045410 A1
(43) Pub. Date: Feb. 6, 2025

(54) SYSTEMS AND METHODS FOR IMPROVING AND UPDATING IDS WITH FUZZING RESULTS

(71) Applicant: Robert Bosch GmbH, Stuttgart (DE)

(72) Inventors: JORGE GUAJARDO MERCHAN, Pittsburgh, PA (US); AMARNATH RAKSHITH, Hemmingen (DE); RING MARTIN, Wildberg (DE); FINN GUNTER, Stuttgart (DE)

(21) Appl. No.: 18/228,013

(22) Filed: Jul. 31, 2023

(51) Int. Cl. G06F 21/57

(52) U.S. Cl. CPC G06F 21/577; G06F 2221/033

(57) ABSTRACT

A method of operating an IDS for a device includes performing a fuzzing operation on a software program being executed on a system under test, the software program corresponding to a deployed software program on the device monitored by the IDS and the system under test being configured to emulate at least one system of the device, the fuzzing operation including supplying fuzzing inputs to the software program, monitoring outputs of the software program, and detecting, based on the outputs, a vulnerability to intrusion in the software program caused by supplying the fuzzing inputs to software program. The method further includes generating and storing a vulnerability entry corresponding to the detected vulnerability, the vulnerability entry including information identifying the detected vulnerability, and updating, based on the vulnerability entry, at least one of a component of the IDS and a code portion of the deployed software program.

### TECHNICAL FIELD

The present disclosure relates to Intrusion Detection Systems (IDSs) for in-vehicle and external networks.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Vehicles, such as cars, trucks, sport utility vehicles, crossovers, mini-vans, or other suitable vehicles include a propulsion system, a braking system, a steering system, and the like. Such vehicle systems may be manual controlled (e.g., by a vehicle operator) and/or autonomously or semi-autonomously controlled (e.g., by one or more autonomous or semi-autonomous vehicle controller). In some examples, autonomous or semi-autonomously vehicle controllers rely on or use various machine learning models for vehicle control decision making.

A controller area network (CAN) bus is the central communication network in several modern systems such as automotive systems, aerospace systems, industrial systems, etc. Some of the nodes on the CAN bus, and more generally on the internal network of the vehicle, may be equipped with remote interfaces. Such interfaces may often be used to enable over-the-air updates, offer additional services, measure usage of applications, and measure usage of certain functions in the ECU to enable maintenance services, etc.

Vehicles may have systems that can detect attacks (e.g. cybersecurity attacks), sometimes called Intrusion Detection Systems (“IDS”). The automotive system of modern vehicles may be equipped with a large number of electronic control units (ECUs) connected by a network using CAN, automotive Ethernet, or other network technology. These ECUs may control the vehicle by running more and more complex software. Furthermore, network connectivity has been increasing further because of sensor data, such as camera streams or LIDAR. The resulting automotive system may be becoming an increasingly attractive target for adversaries interested in compromising this system. The IDS aims at detecting comprises and may collect various types of automotive data to verify consistency and ensure integrity of network traffic and command and control. Recent IDS solutions send such data to a cloud backend for further processing.

### SUMMARY

A method of operating an Intrusion Detection System (IDS) for a device includes performing a fuzzing operation on a software program being executed on a system under test, the software program corresponding to a deployed software program on the device monitored by the IDS and the system under test being configured to emulate at least one system of the device, the fuzzing operation including supplying fuzzing inputs to the software program, monitoring outputs of the software program while being executed on the system under test, and detecting, based on the outputs, a vulnerability to intrusion in the software program caused by supplying the fuzzing inputs to software program. The method further includes generating and storing a vulnerability entry corresponding to the detected vulnerability, the vulnerability entry including information identifying the detected vulnerability, and updating, based on the vulnerability entry, at least one of a component of the IDS and a code portion of the deployed software program.

In other features, supplying the fuzzing inputs includes supplying fuzzing inputs that are configured to cause errors in at least one of a plurality of code portions of the software program. Generating and storing the vulnerability entry includes storing the vulnerability in a vulnerability database. The vulnerability entry includes at least one of a software version of the software program a hardware version being emulated by the system under test executing the software program, a time and date that the vulnerability was detected, the supplied fuzzing inputs, an identification of a fix for the detected vulnerability, and a hash of one or more values contained in the vulnerability entry. The method further includes determining whether the detected vulnerability corresponds to a vulnerability to intrusion for the deployed software program being monitored by the IDS by at least one of determining whether a software version of the software program corresponds to a software version of the deployed software program and determining whether the software version of the software program predates the software version of the deployed software program.

In other features, the updating includes at least one of performing at least one corrective action on the software program and updating the deployed software program on the device based on the at least one corrective action and modifying a configuration of the software program. The method further includes comparing the vulnerability entry to previously detected vulnerabilities and storing, in a vulnerability database, the vulnerability entry in response to a determination that the vulnerability entry does not match any of the previously detected vulnerabilities. The method further includes at least one of generating an alarm in response to detecting the vulnerability and generating instructions to a user of the device in response to detecting the vulnerability. The method further includes, in response to detecting the vulnerability, generating a fingerprint associated with an operating characteristic of the system under test during detection of the vulnerability and updating the IDS based on the fingerprint. The method further includes detecting, by the IDS, an intrusion at the device, supplying fuzzing inputs to the software program based on the detected intrusion at the device, updating at least one of the component of the IDS and the code portion of the deployed software program based on performance of the software program in response to the fuzzing inputs.

An Intrusion Detection System (IDS) includes a fuzzing system configured to perform a fuzzing operation on a software program being executed on a system under test, the software program corresponding to a deployed software program on a device monitored by the IDS and the system under test being configured to emulate at least one system of the device. To perform the fuzzing operation, the fuzzing system is configured to supply fuzzing inputs to the software program, and monitor outputs of the software program while being executed on the system under test. A test controller is configured to detect, based on the outputs, a vulnerability to intrusion in the software program caused by supplying the fuzzing inputs to software program and generate and transmit, to a vulnerability database, a vulnerability entry corresponding to the detected vulnerability, wherein the vulnerability entry includes information identifying the detected vulnerability.

In other features, the IDS further includes the vulnerability database. The IDS further includes a security operations center configured to update, based on the vulnerability entry, at least one of a component of the IDS and a code portion of the deployed software program. To supply the fuzzing inputs, the fuzzing system supplies fuzzing inputs that are configured to cause errors in at least one of a plurality of code portions of the software program. The vulnerability entry includes at least one of a software version of the software program, a hardware version being emulated by the system under test executing the software program, a time and date that the vulnerability was detected, the supplied fuzzing inputs, an identification of a fix for the detected vulnerability, and a hash of one or more values contained in the vulnerability entry. The IDS further includes the system under test.

In other features, at least one of the test controller and a component of a security operations center is configured to determine whether the detected vulnerability corresponds to a vulnerability to intrusion for the deployed software program being monitored by the IDS by at least one of determining whether a software version of the software program corresponds to a software version of the deployed software program and determining whether the software version of the software program predates the software version of the deployed software program. At least one of the test controller and the component of the VSOC is configured to perform at least one corrective action on the software program, in response to detecting the vulnerability, generate a fingerprint associated with an operating characteristic of the system under test during detection of the vulnerability, update the IDS based on the fingerprint, and (iv) update the deployed software program on the device based on the at least one corrective action. The IDS further includes a security operations center configured to at least one of compare the vulnerability entry to previously detected vulnerabilities and store, in the vulnerability database, the vulnerability entry in response to a determination that the vulnerability entry does not match any of the previously detected vulnerabilities and generate an alarm in response to detecting the vulnerability and generate instructions to a user of the device in response to detecting the vulnerability.

A computing device configured to implement at least a portion of an Intrusion Detection System (IDS) includes a processing device configured to execute instructions stored in memory to cause the IDS to perform a fuzzing operation on a software program being executed on a system under test. The software program corresponds to a deployed software program on vehicle device monitored by the IDS and the system under test is configured to emulate at least one system of the device. The fuzzing operation includes supplying fuzzing inputs to the software program, monitoring outputs of the software program while being executed on the system under test, and detecting, based on the outputs, a vulnerability to intrusion in the software program caused by supplying the fuzzing inputs to software program. The processing device is configured to execute the instructions further to generate a vulnerability entry corresponding to the detected vulnerability, the vulnerability entry including information identifying the detected vulnerability, determine whether the vulnerability entry matches any previously detected vulnerabilities associated with the software program, store, in a vulnerability database, the vulnerability entry in response to a determination that the vulnerability entry does not match any of the previously detected vulnerabilities, and update, based on the vulnerability entry, at least one of a component of the IDS and a code portion of the deployed software program.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

FIG. 1 is an example computing device according to the present disclosure.

FIG. 2 is an example system and vehicle that implement an intrusion detection system (IDS) according to the present disclosure.

FIG. 3 illustrates steps of an example method for identifying a vulnerability in an IDS of a vehicle according to the present disclosure.

FIG. 4 illustrates steps of an example method for performing corrective actions in response to identifying a vulnerability in an IDS of a vehicle according to the present disclosure.

FIG. 5 depicts a schematic diagram of an interaction between a computer-controlled machine and a control system, according to the principles of the present disclosure.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

In the drawings, reference numbers may be reused to identify similar and/or identical elements.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Automotive in-vehicle networks may be vulnerable to malicious attacks/intrusions due to large numbers of Electrical Control Units (ECUs), the connectivity of the ECUs to external network, the increased reliance of ECUs on software, etc. Detecting intrusions into networks is an integral part of automotive security to prevent or at least lower an impact of such intrusions. Various methodologies may be implemented to improve automotive security include, but are not limited to, firewalls, whitelisting, blacklisting of messages, and dedicated Intrusion Detection Systems (IDSs) implemented on one or more of the ECUs (e.g., on gateway ECUs). An IDS is a system that monitors predefined systems and/or networks and identifies intrusion attempts based on detection of suspicious, malicious, or undefined system behavior. Operation of the IDS relies on a prerequisite that the intrusion attempt is detectably different from regular system behavior. Types of IDSs include, but are not limited to, a host-based IDS, a network IDS, a distributed IDS, a rule-based IDS, an IDS based on machine learning or deep learning, etc.

Rule-based schemes and algorithms of IDSs are typically not configured to accurately detect intrusions that have not been previously identified. IDSs and IDS methods according to the present disclosure implement fuzzing systems and techniques to accurately detect intrusions that have not been previously identified (i.e., intrusions that do not yet have existing rules-based detection criteria within the IDS).

In fuzzing systems, specially-crafted inputs (or stimuli) are supplied to a particular software program under test. These stimuli are configured to excite a particular path of the program that, when executed, causes a security or safety vulnerability. For example, the stimuli are configured to mimic invalid or semi-valid, unexpected, or random data that may cause software or system crashes, faulty outputs, memory leaks, or other errors. While “invalid,” the stimuli may be similar enough to valid inputs that the stimuli are not initially rejected by the system but cause errors further within a processing chain. Accordingly, the stimuli facilitate identification of a safety- or security-vulnerable code portion. The vulnerable code can then be modified/fixed and the fuzzing process repeats/executes iteratively (e.g., develop software, test, fuzz (craft and input stimuli), find, fix, deploy onto system, etc.). Since systems according to the present disclosure are configured to implement an IDS, fuzzing (e.g., fuzzing on a continuous and iterative basis), and combinations thereof, new vulnerabilities can be identified and corrected. Although described herein with respect to “vulnerabilities,” the principles of the present disclosure may also be applied to detecting other types of performance issues or anomalies, errors, etc.

In some examples, IDSs and IDS methods according to the present disclosure are further configured to implement fingerprinting techniques to detect correct execution of a program under test, deviations from “normal” execution, etc. For example, during a profiling phase, various operating characteristics (e.g., power consumption (R) as a function of a measured voltage V) are measured/recorded and assigned to corresponding individual software tasks. Accordingly, power measurements for each individual software task as well as a set of power measurements for an entire scheduling cycle (e.g., all software tasks) can be obtained and stored (e.g., as a power consumption profile). This profiling may be repeated multiples times to compute an average for each measurement (e.g., to reduce effects of outliers, noise, etc.).

During an operation phase, operating characteristics (e.g., power consumption values) are observed/measured and compared to the stored power consumption profile derived in a previous phase. In one example, a deviation between the observed power consumption for a particular task and the stored power consumption for that task (i.e., in the stored power consumption profile) is obtained. For example, a root mean square may be used to calculate the deviation and obtain a positive value. A deviation larger than a first threshold (e.g., T1) for the corresponding software task may indicate an anomaly.

In another example, a deviation between the observed power consumption for multiple tasks (e.g., a trace including a complete list of software tasks) and the stored power consumption for the multiple tasks is obtained (e.g., using a root mean square calculation). A deviation larger than a second threshold (e.g., T2) for the multiple software tasks may indicate an anomaly.

In still another example, the observed power consumption may be compared to the stored power consumption profile using a model (e.g., a Markov Chain-based model, Bayesian methods based on likelihood, etc.). In this manner, instead of only comparing single values, observed behavior of actual measurements over time can be compared to stored values.

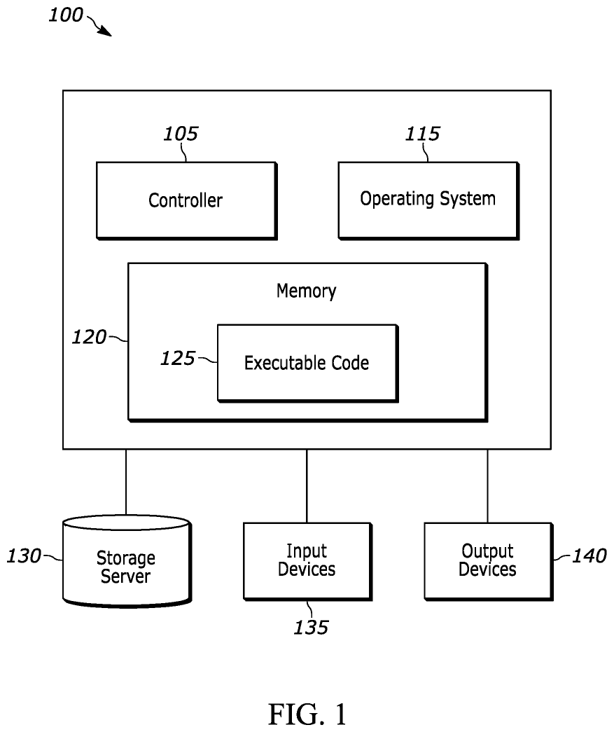

FIG. 1 shows a block diagram of an example computing device 100 configured to implement the IDS and IDS methods according to some embodiments of the disclosure. The computing device 100 may include a controller 105 that may be, for example, a central processing unit (CPU), a chip, or any suitable computing or computational device, an operating system 115, a memory 120, executable code 125, a storage server system 130, input devices 135, and output devices 140. The controller 105 (or one or more controllers or processors, possibly across multiple units or devices) may be configured to carry out methods described herein, and/or to execute or act as the various modules, units, etc. More than one of the computing devices 100 may be included in, and one or more of the computing devices 100 may act as the components of, a system according to embodiments of the disclosure.

The operating system 115 may be or may include any code segment (e.g., one similar to the executable code 125 described herein) designed and/or configured to perform tasks involving coordination, scheduling, arbitration, supervising, controlling or otherwise managing operation of the computing device 100, for example, scheduling execution of software programs or tasks or enabling software programs or other hardware modules or units to communicate. The operating system 115 may be a commercial operating system. It will be noted the operating system 115 may be an optional component, e.g., in some embodiments, a system may include a computing device that does not require or include the operating system 115. For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

The memory 120 may be or may include, for example, Random Access Memory (RAM), read only memory (ROM), Dynamic RAM (DRAM), Synchronous DRAM (SD-RAM), a double data rate (DDR) memory chip, Flash memory, volatile memory, non-volatile memory, cache memory, a buffer, a short term memory unit, a long term memory unit, or other suitable memory units or storage units. The memory 120 may be or may include a plurality of, possibly different memory units. The memory 120 may be a computer or processor non-transitory readable medium, or a computer non-transitory storage medium, e.g., RAM.

The executable code 125 may be any executable code, e.g., an application, a program, a process, task or script. The executable code 125 may be executed by the controller 105 possibly under control of the operating system 115. For example, the executable code 125 may be an application that enforces security in a vehicle as further described herein, for example, detects or prevents cyber-attacks on in-vehicle networks. Although, for the sake of clarity, a single item of the executable code 125 is shown in FIG. 1, a system according to some embodiments of the disclosure may include a plurality of executable code segments similar to the executable code 125 that may be loaded into the memory 120 and cause the controller 105 to carry out methods described herein. Where applicable, the terms “process” and “executable code” may mean the same thing and may be used interchangeably herein. For example, verification, validation and/or authentication of a process may mean verification, validation and/or authentication of executable code.

The storage system 130 may be or may include, for example, flash memory as known in the art, memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in the storage system 130 and may be loaded from the storage system 130 into the memory 120 where it may be processed by the controller 105. In some embodiments, some of the components shown in FIG. 1 may be omitted. For example, the memory 120 may be a nonvolatile memory having the storage capacity of the storage system 130. Accordingly, although shown as a separate component, the storage system 130 may be embedded or included in the memory 120.

The input devices 135 may be or may include any suitable input devices, components or systems, e.g., physical sensors such as accelerometers, tachometers, thermometers, microphones, analog to digital converters, etc., a detachable keyboard or keypad, a mouse and the like. The output devices 140 may include one or more (possibly detachable) displays or monitors, motors, servo motors, speakers and/or any other suitable output devices. Any applicable input/output (I/O) devices may be connected to the computing device 100 as shown by blocks 135 and 140. For example, a wired or wireless network interface card (NIC), a universal serial bus (USB) device, JTAG interface, or external hard drive may be included in the input devices 135 and/or the output devices 140. It will be recognized that any suitable number of the input devices 135 and the output devices 140 may be operatively connected to the computing device 100 as shown by blocks 135 and 140. For example, the input devices 135 and the output devices 140 may be used by a technician or engineer in order to connect to the computing device 100, update software, and the like. Input and/or output devices or components 135 and 140 may be adapted to interface or communicate, with control or other units in a vehicle, e.g., input and/or output devices or components 135 and 140 may include ports that enable the computing device 100 to communicate with an engine control unit or module, a suspension control unit or module, a traction control unit or module, and the like.

Embodiments may include an article such as a computer or processor non-transitory readable medium, or a computer or processor non-transitory storage medium, such as for example memory, a disk drive, or USB flash memory, encoding, including or storing instructions (e.g., computer-executable instructions, which, when executed by a processor or controller, carry out methods disclosed herein), a storage medium such as the memory 120, computer-executable instructions such as the executable code 125, and a controller such as the controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the disclosure may include components such as, but not limited to, a plurality of central processing units (CPU) or any other suitable multi-purpose or specific processors or controllers (e.g., controllers similar to the controller 105), a plurality of input units, a plurality of output units, a plurality of memory units, and a plurality of storage units, etc. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on board, or in-vehicle, system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as the computing device 100.

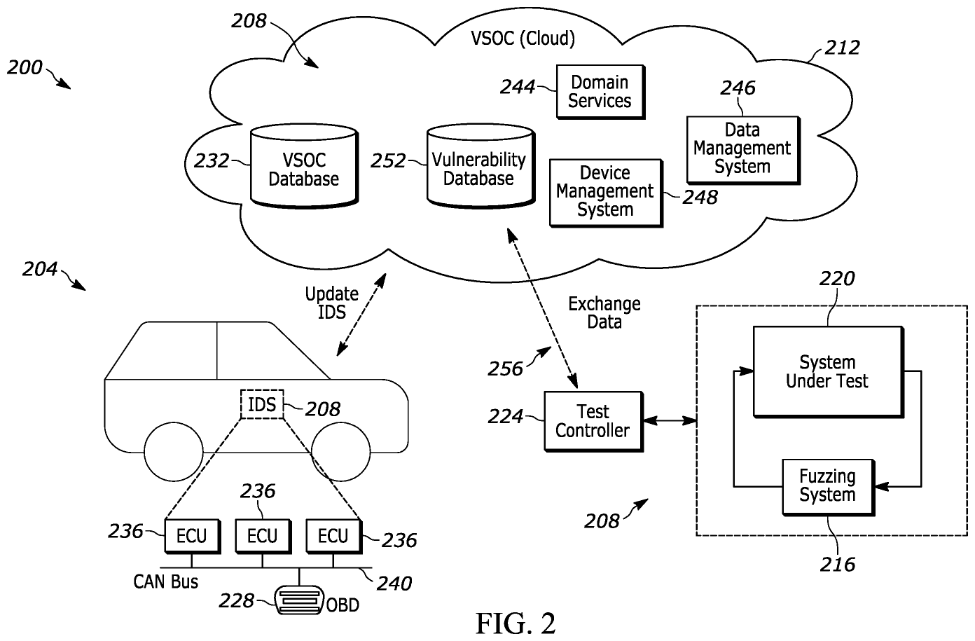

FIG. 2 shows an embodiment of a system 200 and vehicle 204 that may implement an IDS 208 according to the present disclosure. Portions of the IDS 208 are implemented within the vehicle 204 while other portions of the IDS 208 are implemented on one more remote servers (which may be implemented within a cloud computing system and referred to as a cloud backend). In some examples, the cloud computing system may be implemented as a Vehicle Security Operations Center (VSOC) 212 including portions of the IDS 208. The system 200 according to the present disclosure further includes a fuzzing system or agent 216 configured to continuously perform a fuzzing operation on a system under test 220 as described below in more detail (e.g., responsive to a test controller 224). The fuzzing system, the system under test 220, and the test controller 224 may be considered components of the IDS 208 of the present disclosure.

In some example implementations, a device (not shown) may communicate with the IDS 208 and other vehicle systems via a diagnostic port 228 (OBD-II Port) of the vehicle 204 and record CAN messages. Security- and vehicle control-related CAN messages may be sent to the VSOC 212 and stored in a database (e.g., a VSOC database 232). For example, the device communicates with one or more ECUs 236 of the vehicle 204 via a CAN bus 240. The stored CAN messages are available for visualization and further processing and may be accessible for external services, such as testing performed by the test controller 224, the fuzzing system 216, etc. Although described with respect to a CAN and CAN messages, the principles of the present disclosure may be implemented in accordance with other types of vehicle networks (e.g., a local interconnect network (LIN)) or bus standards (e.g., FlexRay), Ethernet networks, in systems that use direct communication links (e.g., using a vehicle connectivity unit), etc.

The VSOC 212 is configured to communicate with the vehicle 204, the test controller 224 (e.g., a server or computing device implementing the test controller 224), etc. In some examples, the VSOC 212 is configured to use (e.g., include or communicate with) domain services 244 to store centralized information. For example, the domain services 244 may store directory information to facilitate communication between users/entities, domains etc. The domain services 244 may include information associated with the VSOC 212, a security incident and event management system (SIEM), the IDS 208, etc.

The VSOC 212 may include or communicate with a data management system 246 and a device management system 248. The data management system 246 may store information associated with data ingestion (e.g., storing data received from the vehicle 204, the test controller 224, other components of the IDS 208, etc.), as well as processing of the stored data. The device management system 248 may be configured to implement digital twin software updates. A digital twin may be a virtual model designed to accurately reflect a physical object. The object being studied—for example, a vehicle or external plug-in device for the diagnostic port of the vehicle—may be outfitted with various sensors related to vital areas of functionality. These sensors may produce data about different aspects of the vehicle's performance, such as energy output, temperature, weather conditions, etc. This data may then be relayed to a processing system and applied to the digital copy. Once informed with such data, the virtual model can be used to run simulations, study performance issues and generate possible improvements, all with the goal of generating valuable insights-which can then be applied back to the original physical object. There may be various software updates associated with the digital twin.

In some examples, the VSOC 212 includes at least one storage location (e.g., the VSOC database 232, the data management system 246, etc.) that stores, for each vehicle (i.e., a unique vehicle identifier associated with each vehicle), information identifying all hardware platforms of the vehicle 204 being monitored, a software version of the software program running on the vehicle 204, a version date of the software program (e.g., a software creation and/or modification date), etc. In some examples, this information corresponds to information provided on a Software Bill of Materials (or SBOM) document.

The IDS 208 according to the present disclosure implements fuzzing (e.g., using the fuzzing system 216) as described below in more detail. For example, the IDS 208 may be implemented as a rule-based IDS configured to execute a main IDS program having a set of rules that are stored on one or more devices that execute the IDS 208 (e.g., an automotive gateway associated with/executed by the VSOC 212, components of the vehicle 204, etc.). The rules may be stored in an integrity protected medium to detect malicious unauthorized modifications to the rules.

The system under test 220 is configured to store and execute a software program that has been deployed in the vehicle 204 (and other vehicles in a fleet of vehicles that includes the vehicle 204). In other words, the system under test 220 operates in accordance with the same software program (e.g., an emulated version of the software program, a software program being executed on a test version of a hardware platform corresponding to the vehicle 204, etc.) that has been deployed in the vehicle 204.

The fuzzing system 216 continuously tests (performs fuzzing on) the software program being executed by the system under test 200. For example, the fuzzing system 216 supplies specially-crafted inputs (or stimuli) to the software program. These stimuli are configured to excite a particular path of the software program that, when executed, causes a security or safety vulnerability. Accordingly, the stimuli facilitate identification of a safety- or security-vulnerable code portion of the software program as it is executed by the system under test 220. More specifically, the fuzzing system 216 according to the present disclosure supplies stimuli configured to detect vulnerabilities not yet identified.

For example, previously-identified vulnerabilities may be stored in a centralized location accessible by the vehicle 204, such as a vulnerability database 252 of the VSOC 212. The fuzzing system 216 performs fuzzing via the system under test 220 to identify vulnerabilities not yet detected and stored in the vulnerability database 252. In other words, the fuzzing system 216 continuously (i.e., iteratively) supplies different stimuli to attempt to cause various faults associated with execution of the software program on the system under test 220. When a fault or vulnerability occurs, the test controller 224 (responsive to the fuzzing system 216) transmits information regarding the identified vulnerability to the VSOC 212 to store the information in the vulnerability database 252 (e.g., as a vulnerability entry). The information may include, but is not limited to, a specific version of the software program being tested using the system under test 220, a version of the hardware platform being emulated by the system under test 220, the specific inputs (i.e., stimuli) that resulted in the vulnerability (i.e., that caused the vulnerability to occur), a hash of any values that can function as a unique identifier for the vulnerability entry, etc. The vulnerability entry may also include previous execution cycles performed by the system under test 220 or fuzzing system 216 prior to detecting the vulnerability, a stack dump or any additional information that would help a tool (or security analyst) determine a precise state of the system under test 220 at the point of occurrence of the vulnerability (and/or immediately preceding the occurrence of the vulnerability).

The information contained in the vulnerability entry may be referred to as a vulnerability information vector (V_fuzz_vuln_id) presented as V_fuzz_vuln_id={SW_version, HW_version, time_found, date_found, exploit, exploit_fix, hash_ID}, wherein SW_version corresponds to the software version of the software program executed by the system under test 220, HW_version corresponds to the hardware version being emulated by the system under test 220, time_found and date_found correspond to a time and date, respectively, that the vulnerability was detected, exploit identifies stimuli resulting in the vulnerability and/or outputs/system behavior caused by the vulnerability, exploit_fix corresponds to a one or more actions/modifications taken to correct the vulnerability (e.g., a software patch), and hash_ID corresponds to a hash of one or more values contained in the vulnerability information vector.

Although described as being a component of the VSOC 212, the vulnerability database 252 may be stored in a same or different location as any of the components of the VSOC 212, the test controller 224 (i.e., a facility containing the test controller 224, the fuzzing system 216, and the system under test 220), a location external to the VSOC 212, etc. When a new (i.e., not previously identified) vulnerability is detected by the fuzzing system 216, the test controller 224 (or other computing device associated with operation of the system under test 220 and the fuzzing system 216) transmits the vulnerability entry (V_fuzz_vuln_id) to the vulnerability database 252 via a secure communication channel 256, such as a wireless communication channel. For example, the wireless communication channel may correspond to an encrypted communication channel.

| The VSOC 212 searches (“queries”) the VSOC database 232 to determine whether a software version of the vulnerability entry corresponds to a software version deployed on any vehicles being monitored by the VSOC 212, including the vehicle 204. If no vehicles are using the corresponding software version, no corrective actions may be taken. In some examples, the VSOC 212 may simply generate and store a log entry indicating details of the vulnerability entry and the query.

If the VSOC 212 identifies a match between the software version of the vulnerability entry and the software version deployed on at least one vehicle being monitored by the VSOC 212, a time and date of the vulnerability entry (i.e., of the software version implemented by/on the system under test 220) is compared to a time and date of the deployed software version. If the time and date of the vulnerability entry are older than (i.e., predate) the time and date of the deployed software version, the VSOC 212 may ignore the vulnerability entry. For example, the time and date of the vulnerability entry predating the time and date of the deployed software version may indicate that the deployed software version has already been modified/updated to fix or otherwise address the vulnerability.

Conversely, if the time and date of the vulnerability are newer than (i.e., do not predate) the time and date of the deployed version, the VSOC 212 and/or other components of the IDS 208 are configured to perform one or more additional processing steps (e.g., corrective actions) to fix the vulnerability. The vulnerable code portion corresponding to the detected vulnerability may be modified. In some examples, the vulnerable code portion may be modified automatically (e.g., by the test controller 224 and/or other components of the VSOC 212, the IDS 208, etc.) and/or by a developer or other user. Once the vulnerable code portion is fixed, the software version may be updated and redeployed to affected vehicles. The fuzzing system 216 continues to perform fuzzing via the system under test 220 and the fuzzing process repeats/executes iteratively. In this manner, since the IDS 208 according to the present disclosure is configured to implement fuzzing on a continuous and iterative basis, new vulnerabilities can be efficiently identified and corrected.

In some examples, the VSOC 212 or other component may determine that the vulnerability is not a potential security vulnerability and instead simply corresponds to unexpected (but not abnormal or potentially exploitable) behavior. Accordingly, rather than fixing the corresponding code portion, relevant portions of the IDS 208 may be updated to prevent similar stimuli from causing the behavior. For example, for a rule-based IDS, rules corresponding to the identified vulnerability may be modified to recognize the stimuli that caused the vulnerability as valid inputs.

In some examples, the VSOC 212 may be configured to perform all or portions of the fuzzing operation to detect vulnerabilities (e.g., in addition to or instead of the fuzzing system 216). For example, a developer or other user may provide fuzzing inputs/stimuli to the VSOC 212 and/or an artificial intelligence or other algorithm (e.g., executed by the data management system 246, the device management system 248, etc.) may provide the fuzzing inputs/stimuli. The VSOC 212 may supply the fuzzing inputs for different software and hardware versions to various systems under test and/or provided to deployed vehicles and IDS clients in a fleet. Any detected vulnerabilities may be provided back to the VSOC 212 for storage in the vulnerability database 252 as described above.

In some examples, one or more components of the IDS 208 may detect a new (i.e., unseen) attack during actual operation of the vehicle 204. In these examples, the IDS 208 may identify steps taken to implement the attack and provide information regarding these steps to the fuzzing system 216. The fuzzing system 216 may be configured to provide corresponding inputs to system under test 200 to duplicate the attack, identify which systems/components of the vehicle 204 are susceptible to the attack, update the vulnerability database 252, and, in some examples, take one or more corrective actions as described herein.

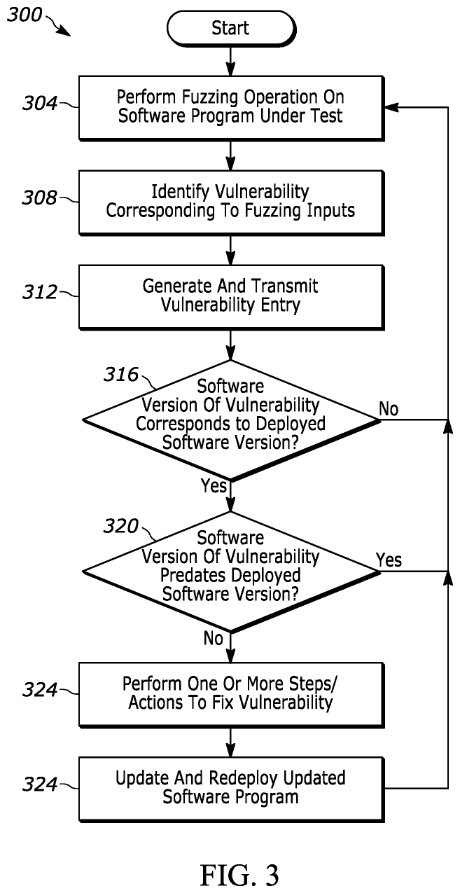

FIG. 3 shows an example method 300 of identifying a vulnerability in an IDS of a vehicle according to the present disclosure. For example, the method 300 is implemented by one or more computing devices such as the computing device 100 and components thereof, such as a controller, a processor executing instructions stored in memory, etc. In embodiments, components implementing one or more steps of the method 300 may be included in one or more computing devices, such as the vehicle 204, the VSOC 212, fuzzing system 216, the test controller 224, etc.

At 304, the method 300 (e.g., the fuzzing system 216) performs a fuzzing operation on a software program being executed on the system under test 220. The fuzzing operation includes supplying inputs to the software program (e.g., stimuli) configured to mimic invalid or semi-valid, unexpected, or random data that may cause software or system crashes, faulty outputs, memory leaks, or other errors. At 308, the method 300 (e.g., the fuzzing system 216, the system under test 220, the test controller 224, etc.) identifies a vulnerability corresponding to one or more fuzzing inputs. As one example, the fuzzing system 216 supplies the inputs and the test controller 224 monitors outputs, states, etc. of the system under test 220. For example, the test controller 224 monitors the system under test 220 to detect outputs or other errors indicating that the fuzzing inputs caused a vulnerability to occur.

At 312, the method 300 (e.g., the test controller) generates a vulnerability entry corresponding to the identified vulnerability and transmits the vulnerability entry to the vulnerability database 252. In some examples, the vulnerability entry (e.g., the vulnerability information vector) may be validated by a validation process prior to being stored in the database. For example, the validation process may be performed by a developer or other user, an artificial intelligence or other algorithm (e.g., executed by the test controller 224, the VSOC 212, etc., and/or combinations thereof. The validation process may be performed on different information paths in the VSOC 212, the system under test 220, etc.

At 316, the method 300 (e.g., the VSOC 212) determines whether a software version of the vulnerability entry corresponds to a software version deployed on any vehicles being monitored by the VSOC 212. If true, the method 300 continues to 320. If false, the method 300 continues to 304 to continue to perform the fuzzing operation.

At 320, the method 300 (e.g., the VSOC 212) determines whether a time and date of the vulnerability entry predates a time and date of the deployed software version. If true, the method 300 ignores the vulnerability entry and continues to 304 to continue to perform the fuzzing operation. If false, the method 300 continues to 324.

At 324, the method 300 (e.g., the VSOC 212 and/or other components of the IDS 208) performs one or more additional processing steps or actions (e.g., corrective actions) to fix the vulnerability. In some examples, the vulnerable code portion may be modified automatically (e.g., by the test controller 224 and/or other components of the VSOC 212, the IDS 208, etc.) and/or by a developer or other user. At 328, the method 300 (e.g., the VSOC 212) updates and redeploys (i.e., uploads) the software version to affected vehicles. The method 300 then continues to 304 and the fuzzing system 216 continues to perform the fuzzing operation.

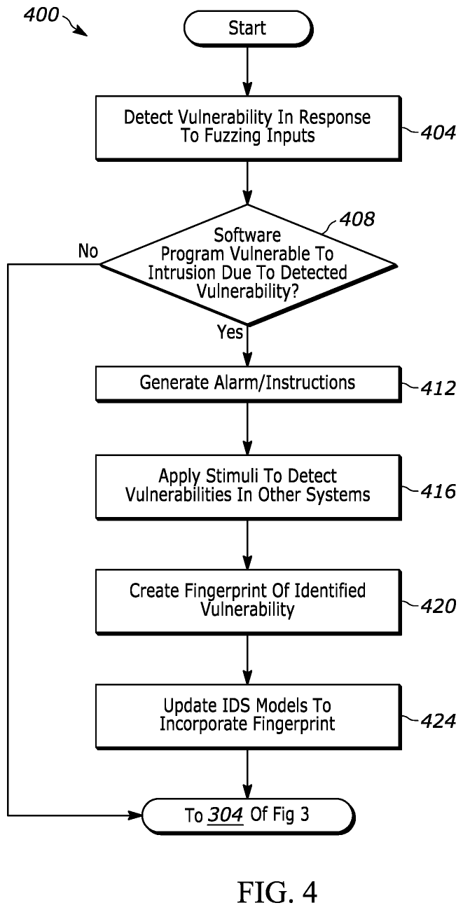

FIG. 4 shows an example method 400 for performing one or more corrective actions in response to identifying a vulnerability in an IDS of a vehicle according to the present disclosure. One or more of the corrective actions may be performed or omitted and the corrective actions may be performed sequentially (in a same or different sequence as shown in FIG. 4), concurrently, conditionally, etc. In other words, one or more of the steps of the method 400 may be optional.

At 404, the method 400 detects a vulnerability in response to fuzzing inputs supplied by the fuzzing system 216 as described above. As described in this example, detecting the vulnerability may include steps related to detecting the vulnerability, generating a vulnerability entry, determining that the software version of the vulnerability entry corresponds to a deployed software version, etc. At 408, the method 400 (e.g., the test controller 224, the VSOC 212, and/or other components of the IDS 208) determines whether the corresponding software version of the software program being tested is actually vulnerable to intrusion as a result of the identified vulnerability. For example, the vulnerability may simply correspond to a minor error or correctable performance issue that does not amount to an intrusion vulnerability. If true, the method 400 continues to 412. If false, the method 400 ends (e.g., returns to 304 of method 300 to continue fuzzing).

At 412, the method 400 generates an alarm (e.g., an audio or visual indicator, a text message, a warning or check engine light, etc.) and instructions to a user or driver for having the vulnerability fixed. As one example, the driver may be instructed to bring the vehicle to a certain state (e.g., parked, turned off, etc.) for the fix to be automatically applied by the VSOC 212. In other examples, the driver may be instructed to bring the vehicle to a dealership or other repair location for the fix to be applied.

At 416, the method 400 (e.g., VSOC 212, in conjunction with one or more of the fuzzing system 216 associated with different vehicles, systems under test, software versions, etc.) supplies the stimuli of the vulnerability entry to other vehicle components, software versions, hardware versions, etc. to determine whether the same stimuli cause vulnerabilities in other systems. In other words, stimuli that were found to cause a vulnerability may be tested in systems where similar inputs may cause a similar vulnerability.

At 420, the method 400 (e.g., the fuzzing system 216) implements fingerprinting techniques to create a fingerprint of the identified vulnerability or exploit. In one example, the fuzzing system 216 generates a power consumption fingerprint associated with the occurrence of the vulnerability. Accordingly, the vulnerability entry may also include a vulnerability fingerprint. In some examples, a machine learning or deep neural network model may be applied to the execution of the software program on the system under test 220 while the fuzzing inputs are supplied. The VSOC 212 determines whether the vulnerability is relevant for any of the vehicles being monitored as describe above and, if true, provides the vulnerability fingerprint to the IDS of the corresponding vehicle (e.g., the IDS 208 of the vehicle 204). The IDS 208 can perform any of the corrective actions described above but also update any operating rules to include detection of the vulnerability fingerprint. Subsequently, if an intrusion attempt is related to the vulnerability detected and represented by the corresponding vulnerability entry, the IDS 208 may detect the intrusion attempt by matching monitored characteristics of the code portion being executed against the vulnerability fingerprint. While described above with respect to power consumption, fingerprinting techniques may also be based on other operating characteristics, such as hardware counters typically available in processors and microcontrollers.

At 424, the method 400 (e.g., the VSOC 212) updates models (e.g., machine learning or deep neural network models) of the IDS 208 to incorporate the vulnerability fingerprint. For example, the IDS 208 may be a signature-based or anomaly-based IDS.

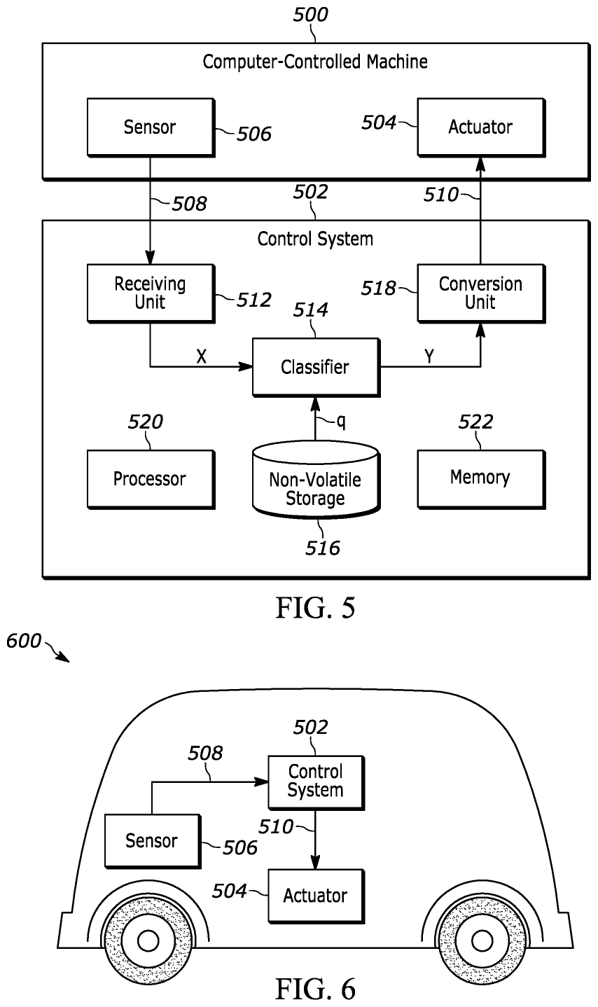

FIGS. 5-11 depict example systems and devices that may implement IDSs and IDS methods according to the present disclosure. FIG. 5 depicts a schematic diagram of an interaction between a computer-controlled machine 500 and control system 502 (including, but not limited to, industrial control system in a manufacturing facility). Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, sound (e.g., a microphone), ultrasonic, and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine-learning (ML) algorithm, such as a neural network. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more IDS methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the IDS methodologies as disclosed herein. Non-volatile storage 516 may also include data supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, microphones, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor and/or microphone as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor or microphone configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

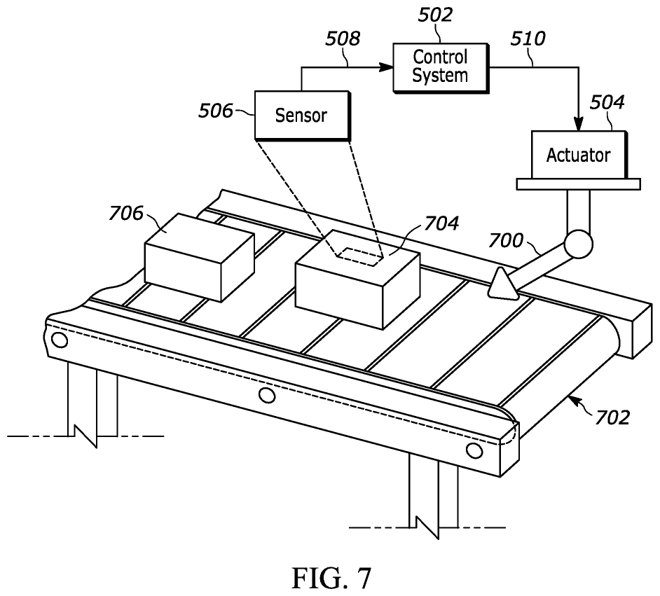

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor or microphone configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

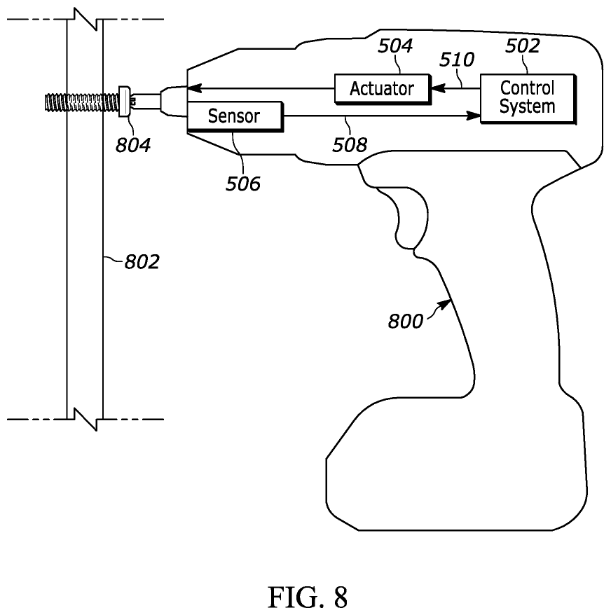

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor or microphone configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

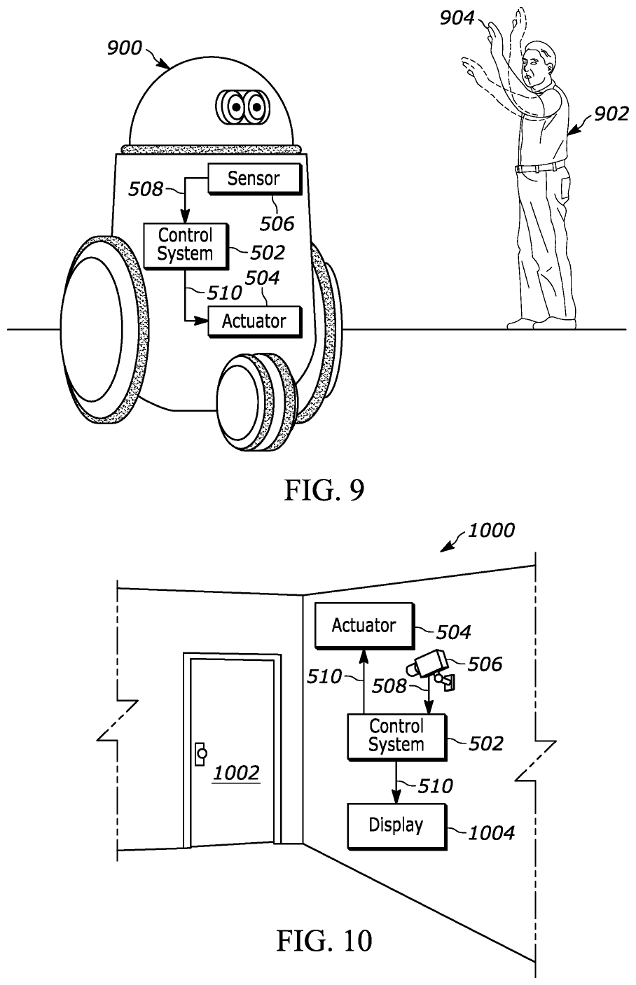

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be a microphone or an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be a microphone or an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

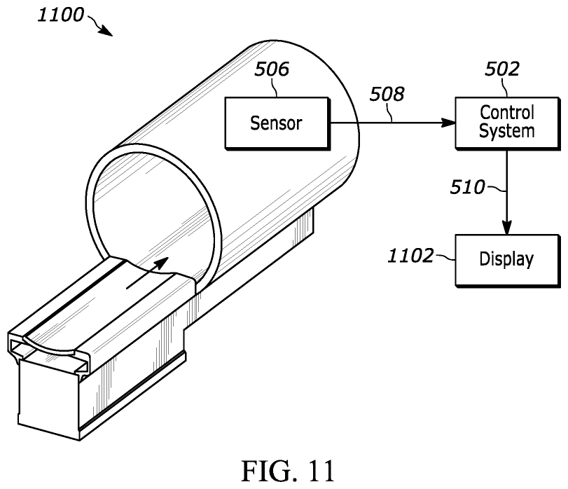

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of operating an Intrusion Detection System (IDS) for a device, the method comprising:
performing a fuzzing operation on a software program being executed on a system under test, wherein the software program corresponds to a deployed software program on the device monitored by the IDS and the system under test is configured to emulate at least one system of the device, the fuzzing operation comprising (i) supplying fuzzing inputs to the software program, (ii) monitoring outputs of the software program while being executed on the system under test, and (iii) detecting, based on the outputs, a vulnerability to intrusion in the software program caused by supplying the fuzzing inputs to software program;
generating and storing a vulnerability entry corresponding to the detected vulnerability, wherein the vulnerability entry includes information identifying the detected vulnerability; and
updating, based on the vulnerability entry, at least one of (i) a component of the IDS and (ii) a code portion of the deployed software program.

2. The method of claim 1, wherein supplying the fuzzing inputs includes supplying fuzzing inputs that are configured to cause errors in at least one of a plurality of code portions of the software program.

3. The method of claim 1, wherein generating and storing the vulnerability entry includes storing the vulnerability in a vulnerability database.

4. The method of claim 1, wherein the vulnerability entry includes at least one of a software version of the software program a hardware version being emulated by the system under test executing the software program, a time and date that the vulnerability was detected, the supplied fuzzing inputs, an identification of a fix for the detected vulnerability, and a hash of one or more values contained in the vulnerability entry.

5. The method of claim 1, further comprising determining whether the detected vulnerability corresponds to a vulnerability to intrusion for the deployed software program being monitored by the IDS by at least one of (i) determining whether a software version of the software program corresponds to a software version of the deployed software program and (ii) determining whether the software version of the software program predates the software version of the deployed software program.

6. The method of claim 1, wherein the updating includes at least one of
performing at least one corrective action on the software program and updating the deployed software program on the device based on the at least one corrective action; and
modifying a configuration of the software program.

7. The method of claim 1, further comprising (i) comparing the vulnerability entry to previously detected vulnerabilities and (ii) storing, in a vulnerability database, the vulnerability entry in response to a determination that the vulnerability entry does not match any of the previously detected vulnerabilities.

8. The method of claim 1, further comprising at least one of (i) generating an alarm in response to detecting the vulnerability and (ii) generating instructions to a user of the device in response to detecting the vulnerability.

9. The method of claim 1, further comprising, in response to detecting the vulnerability, (i) generating a fingerprint associated with an operating characteristic of the system under test during detection of the vulnerability and (ii) updating the IDS based on the fingerprint.

10. The method of claim 1, further comprising:
detecting, by the IDS, an intrusion at the device;
supplying fuzzing inputs to the software program based on the detected intrusion at the device;
updating at least one of (i) the component of the IDS and (ii) the code portion of the deployed software program based on performance of the software program in response to the fuzzing inputs.

11. An Intrusion Detection System (IDS), the IDS comprising:
a fuzzing system configured to perform a fuzzing operation on a software program being executed on a system under test, wherein the software program corresponds to a deployed software program on a device monitored by the IDS and the system under test is configured to emulate at least one system of the device, wherein, to perform the fuzzing operation, the fuzzing system is configured to (i) supply fuzzing inputs to the software program and (ii) monitor outputs of the software program while being executed on the system under test;
a test controller configured to (i) detect, based on the outputs, a vulnerability to intrusion in the software program caused by supplying the fuzzing inputs to software program and (ii) generate and transmit, to a vulnerability database, a vulnerability entry corresponding to the detected vulnerability, wherein the vulnerability entry includes information identifying the detected vulnerability.

12. The IDS of claim 11, further comprising the vulnerability database.

13. The IDS of claim 11, further comprising a security operations center configured to update, based on the vulnerability entry, at least one of (i) a component of the IDS and (ii) a code portion of the deployed software program.

14. The IDS of claim 11, wherein, to supply the fuzzing inputs, the fuzzing system supplies fuzzing inputs that are configured to cause errors in at least one of a plurality of code portions of the software program.

15. The IDS of claim 11, wherein the vulnerability entry includes at least one of a software version of the software program, a hardware version being emulated by the system under test executing the software program, a time and date that the vulnerability was detected, the supplied fuzzing inputs, an identification of a fix for the detected vulnerability, and a hash of one or more values contained in the vulnerability entry.

16. The IDS of claim 11, further comprising the system under test.

17. The IDS of claim 11, wherein at least one of the test controller and a component of a security operations center is configured to determine whether the detected vulnerability corresponds to a vulnerability to intrusion for the deployed software program being monitored by the IDS by at least one of (i) determining whether a software version of the software program corresponds to a software version of the deployed software program and (ii) determining whether the software version of the software program predates the software version of the deployed software program.

18. The IDS of claim 17, wherein the at least one of the test controller and the component of the VSOC is configured to (i) perform at least one corrective action on the software program, (ii) in response to detecting the vulnerability, generate a fingerprint associated with an operating characteristic of the system under test during detection of the vulnerability, (iii) update the IDS based on the fingerprint, and (iv) update the deployed software program on the device based on the at least one corrective action.

19. The IDS of claim 11, further comprising a security operations center configured to at least one of:
compare the vulnerability entry to previously detected vulnerabilities and store, in the vulnerability database, the vulnerability entry in response to a determination that the vulnerability entry does not match any of the previously detected vulnerabilities; and
generate an alarm in response to detecting the vulnerability and generate instructions to a user of the device in response to detecting the vulnerability.

20. A computing device configured to implement at least a portion of an Intrusion Detection System (IDS), the computing device including a processing device configured to execute instructions stored in memory to cause the IDS to:
perform a fuzzing operation on a software program being executed on a system under test, wherein the software program corresponds to a deployed software program on vehicle device monitored by the IDS and the system under test is configured to emulate at least one system of the device, the fuzzing operation comprising (i) supplying fuzzing inputs to the software program, (ii) monitoring outputs of the software program while being executed on the system under test, and (iii) detecting, based on the outputs, a vulnerability to intrusion in the software program caused by supplying the fuzzing inputs to software program;
generate a vulnerability entry corresponding to the detected vulnerability, wherein the vulnerability entry includes information identifying the detected vulnerability;
determine whether the vulnerability entry matches any previously detected vulnerabilities associated with the software program;
store, in a vulnerability database, the vulnerability entry in response to a determination that the vulnerability entry does not match any of the previously detected vulnerabilities; and
update, based on the vulnerability entry, at least one of (i) a component of the IDS and (ii) a code portion of the deployed software program.
